(19) United States
(12) Patent Application Publication
(10) Pub. No.: US 2002/0130819 A1
(43) Pub. Date: Sep. 19, 2002

(54) Display apparatus and method and program for controlling the same

(76) Inventors: Shigehiro Kadota, Tokyo (JP); Minoru Noji, Kanagawa (JP); Hiroto Yasumura, Kanagawa (JP); Kazuyuki Shigeta, Kanagawa (JP); Toshinori Hirobe, Kanagawa (JP)

Correspondence Address: FITZPATRICK CELLA HARPER & SCINTO, 30 ROCKEFELLER PLAZA, NEW YORK, NY, 10112, US

(21) Appl. No.: 09/874,012

(22) Filed: Jun. 6, 2001

(30) Foreign Application Priority Data
Jun. 7, 2000 (JP) 2000-171111
May 1, 2001 (JP) 2001-134472
Jun. 4, 2001 (JP) 2001-168368

(51) Int. Cl. G09G 5/00

(52) U.S. Cl. 345/5

(57) ABSTRACT

A display system for displaying an image to be displayed by an image processing device, divisionally on a plurality of display devices. The display system includes the image processing device, a first display device for displaying an image on a first display unit, a second display device for displaying an image on a second display unit, a first coordinate value input device provided in correspondence with the first display unit, and a second coordinate value input device provided in correspondence with the second display unit, wherein the first display device has an input unit for receiving data from the first coordinate value input device and data from the second coordinate value input device.

### BACKGROUND OF THE INVENTION

1. Field of the Invention

The present invention relates to a display apparatus for displaying images from a plurality of information processing apparatuses and a method and a program for controlling the same.

2. Related Background Art

Conventionally, some display apparatuses comprise a coordinate input device such as a digitizer as coordinate inputting means. The coordinate input device functions as a substitute for a mouse when a presentation is given, and can perform activation of a program and so on. Some coordinate apparatuses attached to conventional display apparatuses have a plurality of output terminals that can be connected to external apparatuses, but output signals of the coordinate input device can be sent to only one information processing apparatus that is actually displayed on the screen, of information processing apparatuses connected to the output terminals.

Therefore, there is a disadvantage that when image outputs of a plurality of information processing apparatuses are displayed at a time by dividing a display screen or making screens overlap one another, the coordinate input device cannot be used as a substitute for a mouse for all the information processing apparatuses.

### SUMMARY OF THE INVENTION

The above described conventional example has a disadvantage that for all the information processing apparatuses connected to a display apparatus having a coordinate input device, the coordinate input device attached to the display apparatus cannot be used as means substituted for a coordinate input device such as a mouse. Therefore, for example, when two or more presenters give a presentation one after another, complicated work is required such that a file is copied from the note PC brought by the presenter to the information processing apparatus connected to the display apparatus, or the information processing apparatus currently connected to the display apparatus is removed and instead the note PC brought by the presenter is connected thereto.

The present invention can solve the problems described above as specific examples, and is intended to provide a display apparatus capable of displaying images from a plurality of information processing apparatuses using one display apparatus, and controlling the plurality of information processing apparatuses using one coordinate input device, and a method and a program for controlling the same.

The display apparatus of the present invention for achieving the above object has the following configuration. That is, a display apparatus displaying images from a plurality of information processing apparatuses, comprising:

image inputting means for inputting respective image signals from the above described plurality of information processing apparatuses;

display controlling means for constructing on a display screen display regions in which respective image signals from the above described plurality of information processing apparatuses are displayed;

inputting means for inputting a signal containing coordinate information;

determining means for determining an information processing apparatus to which the input signal is sent, based on the input signal inputted by the above described inputting means; and

communication means for sending the above described input signal to the information processing apparatus determined by the above described determining means.

Also, preferably, the above described determining means determines an information processing apparatus to which the input signal is sent, based on the coordinate on the above described display screen indicated by the above described input signal.

Also, preferably, the above described display controlling means displays on a first display region an image signal from a first information processing apparatus, and displays on a second display region at least one image signal from a second information processing apparatus in the first display region.

Also, preferably, the above described display controlling means divides the above described display screen into screens, the number of which is equal to the number of the above described plurality of information processing apparatuses, to construct display regions in which respective image signals from the plurality of information processing apparatuses are displayed.

Also, preferably, the above described determining means converts the coordinate information indicated by the above described input signal into absolute coordinate information of a display region corresponding to the information processing apparatus to which the input signal is sent.

The method for controlling the display apparatus according to the present invention for achieving the above object has the following configuration. That is, a method for controlling a display apparatus displaying images from a plurality of information processing apparatuses, comprising:

an image inputting step of inputting respective image signals from the above described plurality of information processing apparatuses;

a display controlling step of constructing on a display screen display regions in which respective image signals from the above described plurality of information processing apparatuses are displayed;

an inputting step of inputting a signal containing coordinate information;

a determining step of determining an information processing apparatus to which the input signal is sent, based on the input signal inputted in the above described inputting step; and

a communicating step of sending the above described input signal to the information processing apparatus determined in the above described determining step.

The program according to the present invention for achieving the above object has the following configuration. That is, a program for making a computer perform control of a display apparatus displaying images from a plurality of information processing apparatuses, comprising:

a program code of an image inputting step of inputting respective image signals from the above described plurality of information processing apparatuses;

a program code of a display controlling step of constructing on a display screen display regions in which respective image signals from the above described plurality of information processing apparatuses are displayed;

a program code of an inputting step of inputting a signal containing coordinate information;

a program code of a determining step of determining an information processing apparatus to which the input signal is sent, based on the input signal inputted in the above described inputting step; and

a program code of a communicating step of sending the above described input signal to the information processing apparatus determined in the above described determining step.

Also, this application includes the following invention as an invention that has an effect of displaying signals from a plurality of information processing apparatuses existing outside a display apparatus enclosure and using one coordinate input device to indicate a position on a screen, and allowing indicated coordinate information to be used selectively by a plurality of information processing apparatuses.

That is, a display apparatus performing display based on a first image signal which is an image signal from a first information processing apparatus that performs a predetermined information processing based on a coordinate signal representing a predetermined position on the screen displayed on the basis of a signal outputted by the apparatus, and a second image signal, which is an image signal from a second information processing apparatus that performs a predetermined information processing based on a coordinate signal representing a predetermined position on the screen displayed on the basis of a signal outputted by the apparatus, characterized by comprising:

a receiving circuit receiving the above described first image signal and the above described second image signal;

a coordinate information receiving circuit receiving signals from a coordinate input device that transforms into a signal an indicated position on a display surface on which a screen based on the above described first image signal or a screen based on the above described second image signal or a screen based on both of the above described first image signal and the above described second image signal is displayed;

a determination circuit determining whether the input signal inputted from the coordinate information receiving circuit is outputted to the above described first information processing apparatus or to the above described second information processing apparatus; and

a communication circuit sending the above described input signal to the information processing apparatus determined by the above described determination circuit.

This invention does not exclude a configuration in which further a signal from an information processing apparatus other than the first and second information processing apparatuses is displayed, and a signal from the coordinate input device is sent to such another information processing apparatus.

Also, for the above described display surface, display surfaces of liquid crystal panels, plasma display panels, CRT and electron-beam display panels using field emission elements, surface conduction emission elements, etc. and so on may be adopted in the case of a direct view type, and a projection screen is equivalent to the display surface in the case of a projection type.

Furthermore, in this invention, this display apparatus may have the above described display surface. Also, this display apparatus may have the above described coordinate input device. At this time, for the above described coordinate input device, one that can be provided in such a manner that it is placed over the above described display surface may be suitably employed.

Also, the above described coordinate input device may suitably employ a configuration of reading electrically or optically the indicated position on the above described display surface.

Also, the above described determination circuit may suitably employ a configuration of determining an information processing apparatus that is to send the above described input signal, according to information that is given externally by a remote control or the like, and a configuration of determining an information processing apparatus that is to send the above described input signal, based on the above described input signal.

Also, here, the sending of the above described input signal to the information processing apparatus determined by the determination circuit includes not only a configuration of sending the above described input signal directly, but also a configuration of converting and sending the signal. In the case where coordinate information on the display surface is directly transferred to the information processing apparatus, each information processing apparatus recognizes on the display surface a display region in which its own image signal is displayed, and computes the coordinate information that is sent, together with position information of the display region in which its own image signal is displayed, whereby the coordinate in the display region can be identified.

On the other hand, the display apparatus has a conversion circuit, and the above described input signal is converted so that the information processing apparatus to which the signal based on the above described input signal is sent can use the signal sent from this display apparatus without using information indicating where the display region in which the image signal outputted by the information processing apparatus is positioned on the above described display surface, whereby each information processing apparatus can use coordinate information from the display apparatus without recognizing the display region in which its own image signal is displayed.

### BRIEF DESCRIPTION OF THE DRAWINGS

FIG. 1 is a block diagram showing a configuration of a display apparatus of Embodiment 1;

FIG. 2 shows one example of a display form of the display apparatus of Embodiment 1;

FIG. 3 is a flowchart showing processing performed in the display apparatus of Embodiment 1;

FIG. 4 shows one example of the display form of the display apparatus of Embodiment 2;

FIG. 5 is a flowchart showing processing performed in the display apparatus of Embodiment 2;

FIG. 6 shows one example of the display form of the display apparatus of Embodiment 3;

FIG. 7 is a flowchart showing processing performed in the display apparatus of Embodiment 3;

FIG. 8 shows one example of the display form of the display apparatus of Embodiment 4;

FIG. 9 is a flowchart showing processing performed in the display apparatus of Embodiment 4;

FIG. 10 shows one example of the display form of the display apparatus of Embodiment 5;

FIG. 11 is a flowchart showing processing performed in the display apparatus of Embodiment 5;

FIG. 12 shows one example of the display form of the display apparatus of Embodiment 6; and

FIG. 13 is a flowchart showing processing performed in the display apparatus of Embodiment 6.

### DETAILED DESCRIPTION OF THE PREFERRED EMBODIMENTS

Preferred embodiments of the present invention will be described in detail below, referring to the drawings.

### Embodiment 1

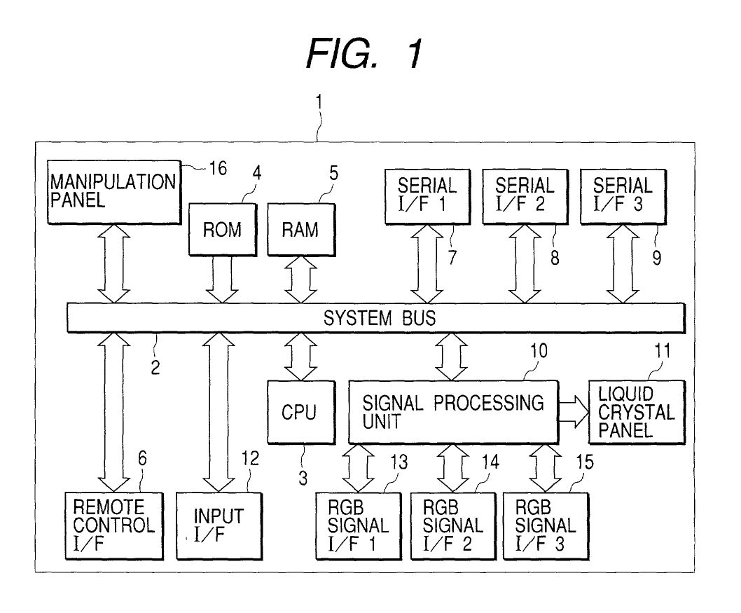

FIG. 1 is a block diagram showing a configuration of a display apparatus of Embodiment 1.

In FIG. 1, reference numeral 1 denotes a display apparatus. Reference numeral 2 denotes a system bus interconnecting various kinds of devices in the display apparatus 1. Reference numeral 3 denotes a CPU controlling the entire display apparatus, which performs various kinds of processing. Reference numeral 4 denotes a ROM, which stores various kinds of programs executed by the CPU 3 including programs for achieving the present invention. Reference numeral 5 denotes a RAM, which functions as working areas for various kinds of data used by the CPU 3, and temporary save areas. Reference numeral 6 denotes a remote control interface (I/F) for communicating with a remote control unit for the display apparatus 1. Reference numerals 7 to 9 denote, respectively, serial interfaces (I/F) 1 to 3 being circuits for communicating with external apparatuses such as information processing apparatuses.

Reference numeral 10 denotes a signal processing unit, which is a circuit for converting RGB signals inputted from RGB signal interfaces (I/F) 13 to 15 into image forming signals. A liquid crystal panel 11 is a display unit displaying an image that is projected onto a projector. In the case of a reflection type, the image displayed on the liquid crystal panel 11 is reflected by shining light on the liquid crystal panel 11, and the image is projected onto the projector screen by way of an optical system. In the case of a transparent type, the image displayed on the liquid crystal panel 11 is projected onto the projector screen by way of the optical system, by shining light from behind the liquid crystal panel 11. Description of the remainder following the optical system is omitted here.

Reference numeral 12 denotes an input interface (I/F) being a circuit receiving signals from the coordinate input device such as a digitizer. Reference numerals 13 to 15 denote, respectively, RGB signal interfaces (I/F) 1 to 3, which are interface circuits for video output signals for external apparatuses such as information processing apparatuses. The RGB signal interfaces 13 to 15 are connected to the signal processing unit 10, and the video by the RGB signal is displayed on the liquid crystal panel 11, thereby being projected onto the projector screen. Reference numeral 16 denotes a manipulation panel of the display apparatus 1. Furthermore, the RGB signal interfaces 13 to 15 may be either analog or digital interfaces.

In each of the following embodiments, the case will be described where the display apparatus 1 is used to project images of two or three information processing apparatuses. For projecting images of three information processing apparatuses onto the display apparatus 1, the RGB output signals of the three information processing apparatuses are inputted in the RGB signal interfaces 13 to 15 of the display apparatus, respectively. Now, assume that the information processing apparatus that is connected to the RGB signal interface 13 is the information processing apparatus 1, the information processing apparatus that is connected to the RGB signal interface 14 is the information processing apparatus 2, the information processing apparatus that is connected to the RGB signal interface 15 is the information processing apparatus 3.

In the initial condition, the display apparatus 1 has the image of the information processing apparatus 1 projected thereonto, and transfers the input signal of coordinate information, etc. from the input interface 12 to the information processing apparatus 1 via the serial interface 7.

When the input of the RGB signal that is displayed is changed from the input of the RGB signal from the information processing apparatus 1 to the input of the RGB signal from the information processing apparatus 2 by the manipulation panel 16 or the remote control 6, the CPU 3 changes the input of the RGB signal that is displayed from what is inputted from the RGB signal interface 13 to what is inputted from the RGB signal interface 14, and changes the output end for the input signal of coordinate information, etc. from the input interface 12, from the serial interface 7 to the serial interface 8, to transfer the same to the information processing apparatus 2 via the serial interface 8, in accordance with the program stored in the ROM 4.

When the input of the RGB signal that is displayed is changed from the input of the RGB signal from the information processing apparatus 2 to the input of the RGB signal from the information processing apparatus 3 by the manipulation panel 16 or the remote control 6, the CPU 3 changes the input of the RGB signal that is displayed from what is inputted from the RGB signal interface 14 to what is inputted from the RGB signal interface 15, and changes the output end for the input signal of coordinate information, etc. from the input interface 12, from the serial interface 8 to the serial interface 9, to transfer the same to the information processing apparatus 3 via the serial interface 9, in accordance with the program stored in the ROM 4.

In the case where the input of the RGB signal is changed from the information processing apparatus 1 to the information processing apparatus 3, from the information processing apparatus 2 to the information processing apparatus 1, and from the information processing apparatus 3 to the information processing apparatus 1 by the manipulation panel 16 or the remote control 6, similarly, the CPU 3 changes the input source for the input of the RGB signal and changes the serial interface being the output end for the input signal of coordinate information, etc. from the input interface 12 to transfer the same to each information processing apparatus via the serial interface for which the input signal of coordinate information, etc. is defined, in accordance with the program stored in the ROM 4.

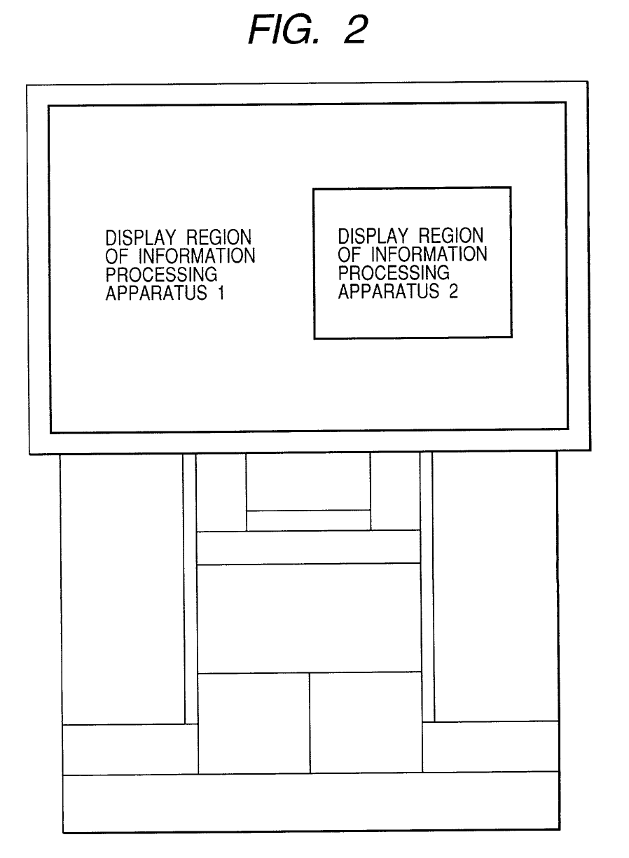

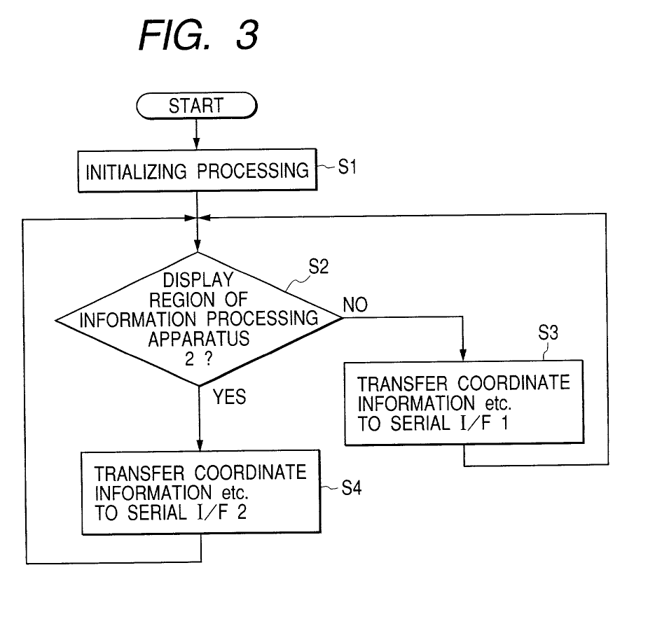

Furthermore, in this embodiment, not only the output end for the input signal of coordinate information, etc. can be changed through external manipulation using the manipulation panel 16 and the remote control 6, but also the output end can be determined based on the input signal. The configuration thereof will be described using FIGS. 2 and 3.

FIG. 2 shows one example of the display form for the display apparatus of Embodiment 1.

In Embodiment 1, the situation is shown in which a display region being a sub screen is provided in the display region of the display apparatus 1 on which the image of the information processing apparatus 1 is projected, and the image of the information processing apparatus 2 is projected onto the sub display region. The configuration in which the image of the information processing apparatus 2 is projected onto the sub display region is not particularly limited. Also, the positions of the display regions of the information processing apparatuses 1 and 2 are not particularly limited but, for example, each of the screens of the information processing apparatuses 1 and 2 may be displayed in the form of multi-window using a general-purpose widow system such as X Window.

Processing performed in the display apparatus of Embodiment 1 will now be described, using FIG. 3.

FIG. 3 is a flowchart showing processing performed in the display apparatus of Embodiment 1.

Furthermore, in Embodiment 1, manipulation on the coordinate input device emulates an operation of a mouse, thereby sending the input signal constituted by coordinate information and button information to the information processing apparatus.

First, at step S1, initializing processing for the coordinate input device is performed. This initializing processing is carried out when the power is turned on, the reset button is pushed, and so on. At step S2, whether or not the coordinate of the coordinate input device exists in the display region of the information processing apparatus 2 is determined. If the coordinate of the coordinate input device does not exist in the display region of the information processing apparatus 2, namely if it exists in the display region of the information processing apparatus 1 (if the result of the step S2 is NO), the process proceeds to step S3, where the input signal of coordinate information, etc. is sent to the serial interface 7 connected to the information processing apparatus 1, and the process returns to step S2.

On the other hand, if the coordinate of the coordinate input device exists in the display region of the information processing apparatus 2 (if the result of the step S2 is YES), the process proceeds to step S4, where the input signal of coordinate information, etc. is sent to the serial interface 8 connected to the information processing apparatus 2, and the process returns to step S2. In this case, the coordinate is converted into an absolute coordinate of the display region of the information processing apparatus 2 by CPU 3, and the absolute signal is sent to the information processing apparatus 2.

Furthermore, the reason why at step S2, whether or not the coordinate of the coordinate input device exists in the display region of the information processing apparatus 2 is determined before whether or not the coordinate exists in the display region of the information processing apparatus 1 is determined is that the display region of the information processing apparatus 2 has no portion covered with the display region of the information processing apparatus 1.

As described above, according to Embodiment 1, based on a indicated coordinate by the coordinate input device, the information processing apparatus to which the input signal obtained from the indicated signal is outputted is selected, at the time of displaying the image of the information processing apparatus 2 as the sub display region of the display region of the information processing apparatus 1. Then, the input signal of coordinate information, etc. of the coordinate input device can be sent to this selected information processing apparatus. Thereby, a plurality of information processing apparatuses can be connected to one display apparatus 1 having a coordinate input device to use the coordinate input device as the coordinate input device of each information processing apparatus.

### Embodiment 2

In Embodiment 2, the case will be described where screens of three information processing apparatuses are projected onto the display apparatus 1.

Furthermore, since the configuration of the display apparatus 1 is same as that of Embodiment 1, the explanation thereof will not be presented.

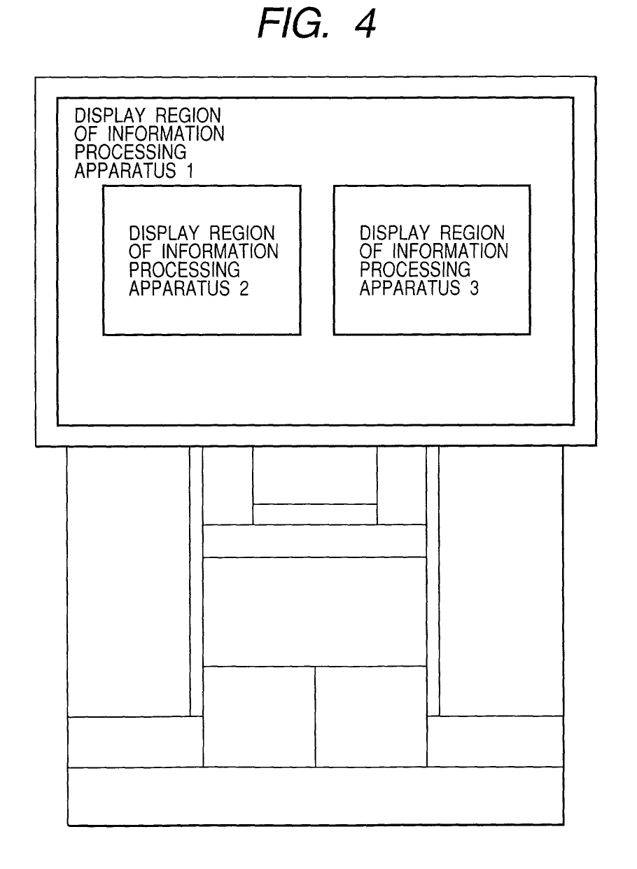

One example of the display form for the display apparatus 1 of Embodiment 2 will now be described, using FIG. 4.

FIG. 4 shows one example of the display form for the display apparatus of Embodiment 2.

In Embodiment 2, the situation is shown in which two sub display regions are provided in the display region of the display apparatus 1 on which the image of the information processing apparatus 1 is projected, and the images of the information processing apparatuses 2 and 3 are projected onto the respective sub display regions. The configuration in which the images of the information processing apparatuses 2 and 3 are projected onto the sub display regions is not particularly limited. Also, the positions of the display regions of the information processing apparatuses 1 to 3 are not particularly limited but, for example, each of the screens of the information processing apparatuses 1 to 3 may be displayed in the form of multi-window using a general-purpose window system such as X Window.

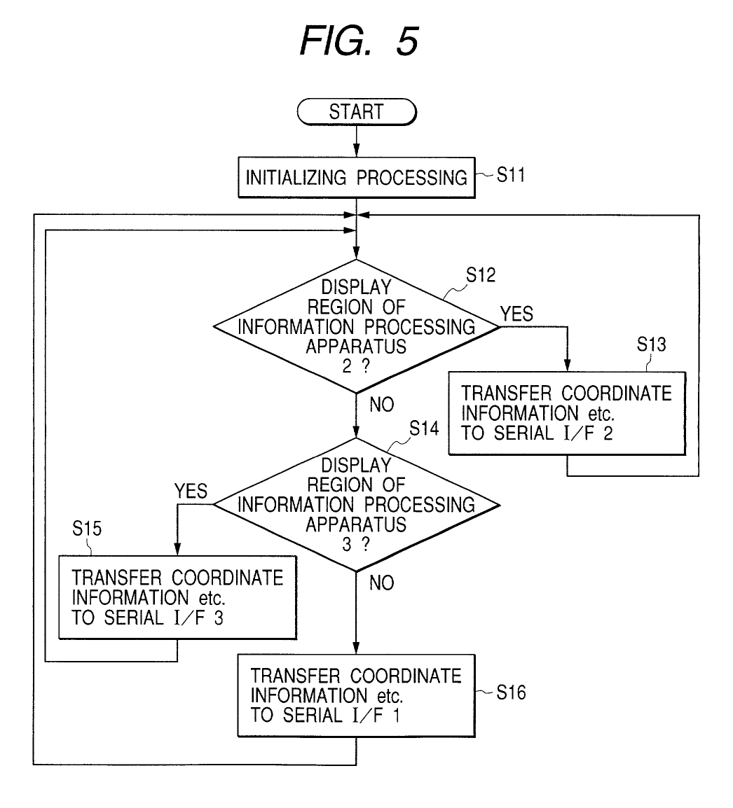

Processing performed in the display apparatus of Embodiment 2 will now be described, using FIG. 5.

FIG. 5 is a flowchart showing processing performed in the display apparatus of Embodiment 2.

Furthermore, in Embodiment 2, manipulation on the coordinate input device emulates an operation of a mouse, thereby sending the input signal constituted by coordinate information and button information to the information processing apparatus.

First, at step S11, initializing processing for the coordinate input device is performed. At step S12, whether or not the coordinate of the coordinate input device exists in the display region of the information processing apparatus 2 is determined. If the coordinate of the coordinate input device exists in the display region of the information processing apparatus 2 (if the result of the step S12 is YES), the process proceeds to step S13, where the input signal of coordinate information, etc. is sent to the serial interface 8 connected to the information processing apparatus 2, and the process returns to step S12. In this case, the coordinate is converted into an absolute coordinate of the display region of the information processing apparatus 2, and the absolute coordinate is sent to the information processing apparatus 2.

Furthermore, the reason why at step S12, whether or not the coordinate of the coordinate input device exists in the display region of the information processing apparatus 2 is determined before whether or not the coordinate exists in the display region of the information processing apparatus 1 is determined is that the display region of the information processing apparatus 2 has no portion covered with the display region of the information processing apparatus 1.

On the other hand, if the coordinate of the coordinate input device does not exist in the display region of the information processing apparatus 2 (if the result of the step S12 is NO), the process proceeds to step S14, where whether or not the coordinate of the coordinate input device exits in the display region of the information processing apparatus 3 is determined. If the coordinate of the coordinate input device exists in the display region of the information processing apparatus 3 (if the result of step S14 is YES), the process proceeds to step S15, where the input signal of coordinate information, etc. is sent to the serial interface 9 connected to the information processing apparatus 3, and the process returns to step S12. In this case, the coordinate is converted into an absolute coordinate of the display region of the information processing apparatus 3, the absolute coordinate is sent to the information processing apparatus 3.

Furthermore, the reason why at step S14, whether or not the coordinate of the coordinate input device exists in the display region of the information processing apparatus 3 is determined before whether or not the coordinate exists in the display region of the information processing apparatus 1 is determined is that the display region of the information processing apparatus 3 has no portion covered with the display region of the information processing apparatus 1.

On the other hand, if the coordinate of the coordinate input device does not exist in the display region of the information processing apparatus 3 (if the result of the step S14 is NO), the process proceeds to step S16, where the input signal of coordinate information, etc. is sent to the serial interface 7 connected to the information processing apparatus 1, and the process returns to step S12.

As described above, according to Embodiment 2, based on a indicated coordinate by the coordinate input device, the information processing apparatus to which the input signal obtained from the indicated coordinate is outputted is selected, at the time of displaying the images of the information processing apparatuses 2 and 3 as the sub display region of the display region of the information processing apparatus 1. Then, the input signal of coordinate information, etc. of the coordinate input device can be sent to this selected information processing apparatus. Thereby, a plurality of information processing apparatuses can be connected to one display apparatus 1 having a coordinate input device to use the coordinate input device as the coordinate input device of each information processing apparatus.

### Embodiment 3

In Embodiment 3, the case will be described where screens of three information processing apparatuses are projected onto the display apparatus 1.

Furthermore, since the configuration of the display apparatus 1 is same as that of Embodiment 1, the explanation thereof will not be presented.

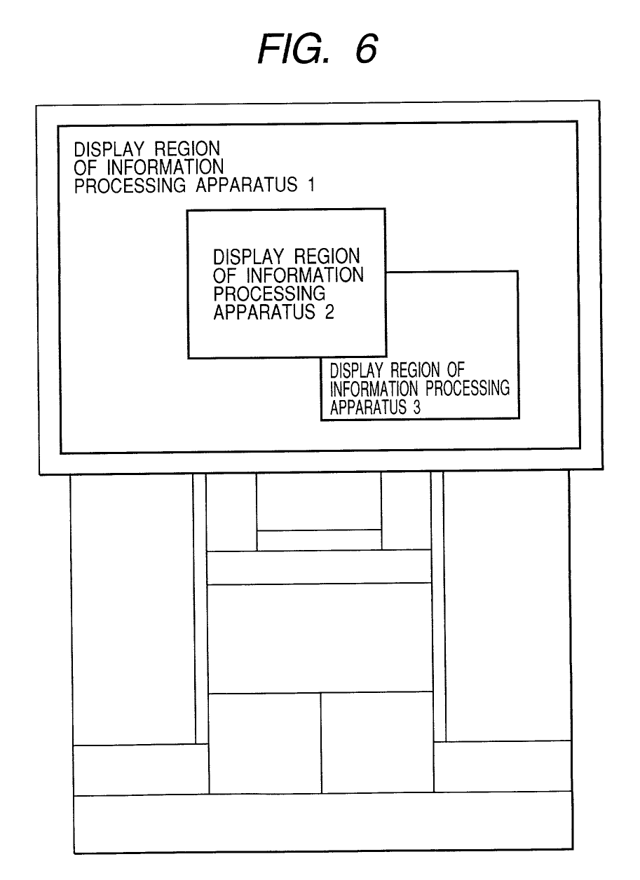

One example of the display form for the display apparatus 1 of Embodiment 3 will now be described, using FIG. 6.

FIG. 6 shows one example of the display form for the display apparatus of Embodiment 3.

In Embodiment 3, the situation is shown in which two sub display regions are provided in the display region of the display apparatus 1 on which the image of the information processing apparatus 1 is projected, and the images of the information processing apparatuses 2 and 3 are projected onto the respective sub display regions. In this case, part of the display region of the information processing apparatus 3 is hidden by the display region of the information processing apparatus 2. The configuration in which the images of the information processing apparatuses 2 and 3 are projected onto the sub display regions is not particularly limited. Also, the positions of the display regions of the information processing apparatuses 1 to 3 are not particularly limited but, for example, each of the screens of the information processing apparatuses 1 to 3 may be displayed in the form of multi-window using a general-purpose window system such as X Window.

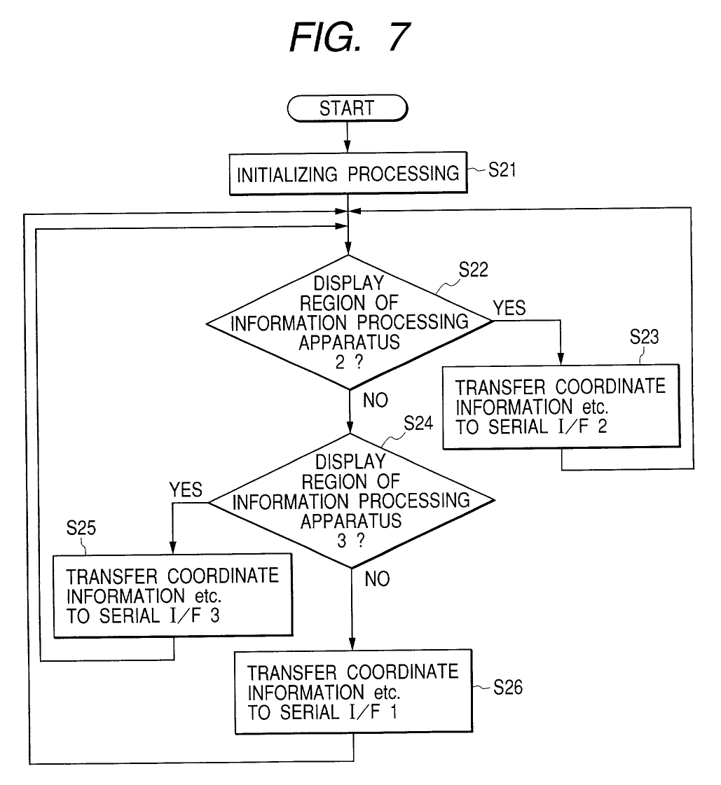

Processing performed in the display apparatus of Embodiment 3 will now be described, using FIG. 7.

FIG. 7 is a flowchart showing processing performed in the display apparatus of Embodiment 3.

Furthermore, in Embodiment 3, manipulation on the coordinate input device emulates an operation of a mouse, thereby sending the input signal constituted by coordinate information and button information to the information processing apparatus.

First, at step S21, initializing processing for the coordinate input device is performed. At step S22, whether or not the coordinate of the coordinate input device exists in the display region of the information processing apparatus 2 is determined. If the coordinate of the coordinate input device exists in the display region of the information processing apparatus 2 (if the result of the step S22 is YES), the process proceeds to step S23, where the input signal of coordinate information, etc. is sent to the serial interface 8 connected to the information processing apparatus 2, and the process returns to step S22. In this case, the coordinate is converted into an absolute coordinate of the display region of the information processing apparatus 2, and the absolute coordinate is sent to the information processing apparatus 2.

Furthermore, the reason why at step S22, whether or not the coordinate of the coordinate input device exists in the display region of the information processing apparatus 2 is determined before whether or not the coordinate exists in the display regions of the information processing apparatuses 1 and 3 is determined is that the display region of the information processing apparatus 2 has no portion covered with the display regions of the information processing apparatuses 1 and 3.

On the other hand, if the coordinate of the coordinate input device does not exist in the display region of the information processing apparatus 2 (if the result of the step S22 is NO), the process proceeds to step S24, where whether or not the coordinate of the coordinate input device exits in the display region of the information processing apparatus 3 is determined. If the coordinate of the coordinate input device exists in the display region of the information processing apparatus 3 (if the result of step S24 is YES), the process proceeds to step S25, where the input signal of coordinate information, etc. is sent to the serial interface 9 connected to the information processing apparatus 3, and the process returns to step S22. In this case, the coordinate is converted into an absolute coordinate of the display region of the information processing apparatus 3, the absolute coordinate is sent to the information processing apparatus 3.

Furthermore, the reason why at step S24, whether or not the coordinate of the coordinate input device exists in the display region of the information processing apparatus 3 is determined before whether or not the coordinate exists in the display region of the information processing apparatus 1 is determined is that the display region of the information processing apparatus 3 has no portion covered with the display region of the information processing apparatus 1.

On the other hand, if the coordinate of the coordinate input device does not exist in the display region of the information processing apparatus 3 (if the result of the step S24 is NO), the process proceeds to step S26, where the input signal of coordinate information, etc. is sent to the serial interface 7 connected to the information processing apparatus 1, and the process returns to step S22.

As described above, according to Embodiment 3, based on a indicated coordinate by the coordinate input device, the information processing apparatus to which the input signal obtained from the indicated signal is outputted is selected, at the time of displaying the images of the information processing apparatuses 2 and 3 as the sub display region of the display region of the information processing apparatus 1. Then, the input signal of coordinate information, etc. of the coordinate input device can be sent to this selected information processing apparatus. Thereby, a plurality of information processing apparatuses can be connected to one display apparatus 1 having a coordinate input device to use the coordinate input device as the coordinate input device of each information processing apparatus.

### Embodiment 4

In Embodiment 4, the case will be described where screens of three information processing apparatuses are projected onto the display apparatus 1.

Furthermore, since the configuration of the display apparatus 1 is same as that of Embodiment 1, the explanation thereof will not be presented.

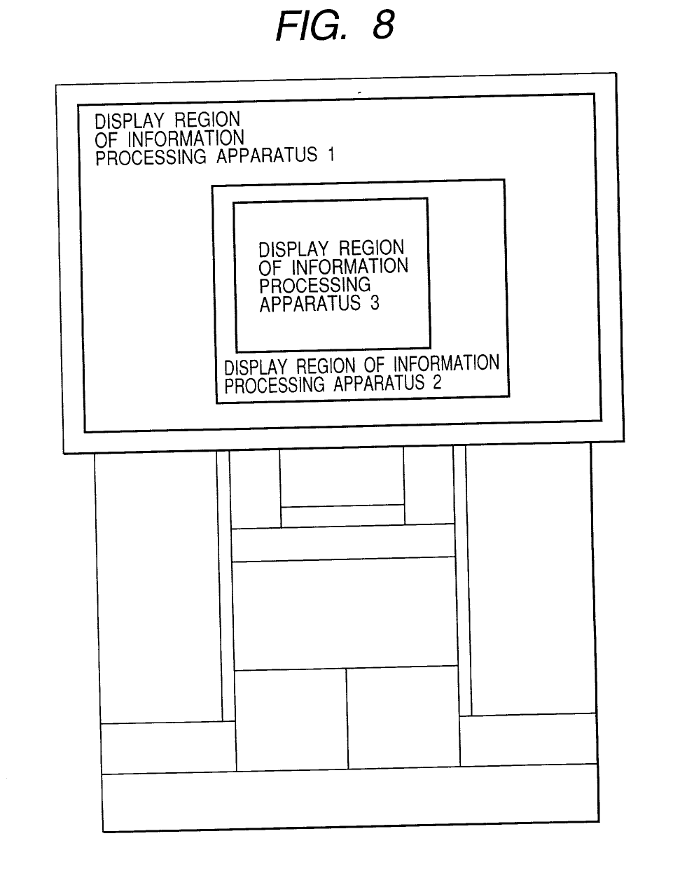

One example of the display form for the display apparatus 1 of Embodiment 4 will now be described, using FIG. 8.

FIG. 8 shows one example of the display form for the display apparatus of Embodiment 4.

In Embodiment 4, the situation is shown in which two sub regions are provided in the display region of the display apparatus 1 on which the image of the information processing apparatus 1 is projected, and the images of the information processing apparatuses 2 and 3 are projected onto the respective sub display regions. In this case, the display region of the information processing apparatus 3 is displayed inside the display region of the information processing apparatus 2. The configuration in which the images of the information processing apparatuses 2 and 3 are projected onto the sub display regions is not particularly limited. Also, the positions of the display regions of the information processing apparatuses 1 to 3 are not particularly limited but, for example, each of the screens of the information processing apparatuses 1 to 3 may be displayed in the form of multi-window using a general-purpose window system such as X Window.

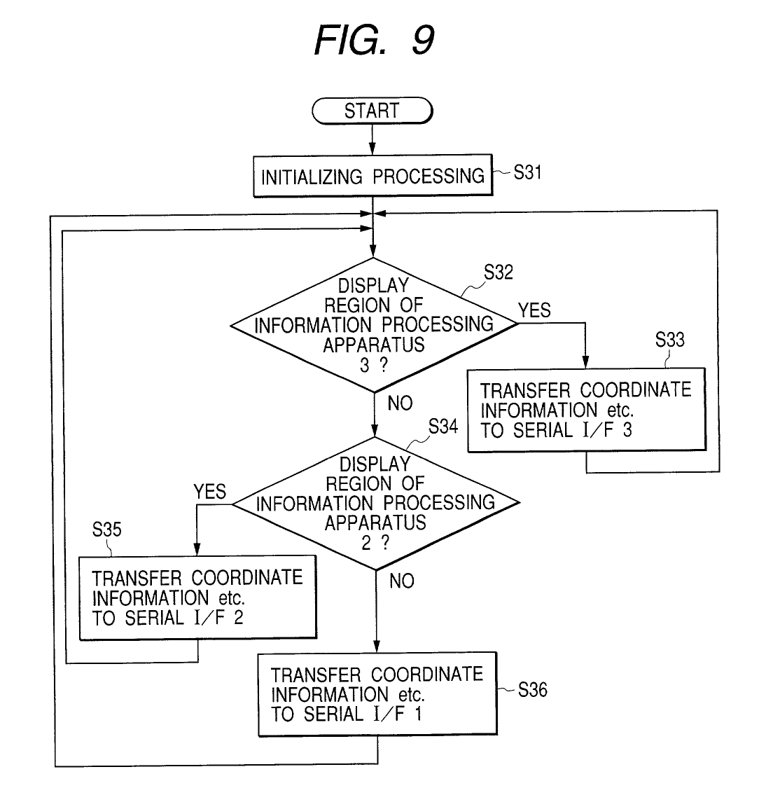

Processing performed in the display apparatus of Embodiment 4 will now be described, using FIG. 9.

FIG. 9 is a flowchart showing processing performed in the display apparatus of Embodiment 4.

Furthermore, in Embodiment 4, manipulation on the coordinate input device emulates an operation of a mouse, thereby sending the input signal constituted by coordinate information and button information to the information processing apparatus.

First, at step S31, initializing processing for the coordinate input device is performed. At step S32, whether or not the coordinate of the coordinate input device exists in the display region of the information processing apparatus 3 is determined. If the coordinate of the coordinate input device exists in the display region of the information processing apparatus 3 (if the result of the step S32 is YES), the process proceeds to step S33, where the input signal of coordinate information, etc. is sent to the serial interface 9 connected to the information processing apparatus 3, and the process returns to step S32. In this case, the coordinate is converted into an absolute coordinate of the display region of the information processing apparatus 3, and the absolute coordinate is sent to the information processing apparatus 3.

Furthermore, the reason why at step S32, whether or not the coordinate of the coordinate input device exists in the display region of the information processing apparatus 3 is determined before whether or not the coordinate exists in the display regions of the information processing apparatuses 1 and 2 is determined is that the display region of the information processing apparatus 3 has no portion covered with the display regions of the information processing apparatuses 1 and 2.

On the other hand, if the coordinate of the coordinate input device does not exist in the display region of the information processing apparatus 3 (if the result of the step S32 is NO), the process proceeds to step S34, where whether or not the coordinate of the coordinate input device exits in the display region of the information processing apparatus 2 is determined. If the coordinate of the coordinate input device exists in the display region of the information processing apparatus 2 (if the result of step S34 is YES), the process proceeds to step S35, where the input signal of coordinate information, etc. is sent to the serial interface 8 connected to the information processing apparatus 2, and the process returns to step S32. In this case, the coordinate is converted into an absolute coordinate of the display region of the information processing apparatus 2, the absolute coordinate is sent to the information processing apparatus 2.

Furthermore, the reason why at step S34, whether or not the coordinate of the coordinate input device exists in the display region of the information processing apparatus 2 is determined before whether or not the coordinate exists in the display region of the information processing apparatus 1 is determined is that the display region of the information processing apparatus 2 has no portion covered with the display region of the information processing apparatus 1.

On the other hand, if the coordinate of the coordinate input device does not exist in the display region of the information processing apparatus 2 (if the result of the step S34 is NO), the process proceeds to step S36, where the input signal of coordinate information, etc. is sent to the serial interface 7 connected to the information processing apparatus 1, and the process returns to step S32.

As described above, according to Embodiment 4, based on a indicated coordinate by the coordinate input device, the information processing apparatus to which the input signal obtained from the indicated coordinate is outputted is selected, at the time of displaying the images of the information processing apparatuses 2 and 3 as the sub display region of the display region of the information processing apparatus 1. Then, the input signal of coordinate information, etc. of the coordinate input device can be sent to this selected information processing apparatus. Thereby, a plurality of information processing apparatuses can be connected to one display apparatus 1 having a coordinate input device to use the coordinate input device as the coordinate input device of each information processing apparatus.

### Embodiment 5

In Embodiment 5, the case will be described where screens of two information processing apparatuses are projected onto the display apparatus 1.

Furthermore, since the configuration of the display apparatus 1 is same as that of Embodiment 1, the explanation thereof will not be presented.

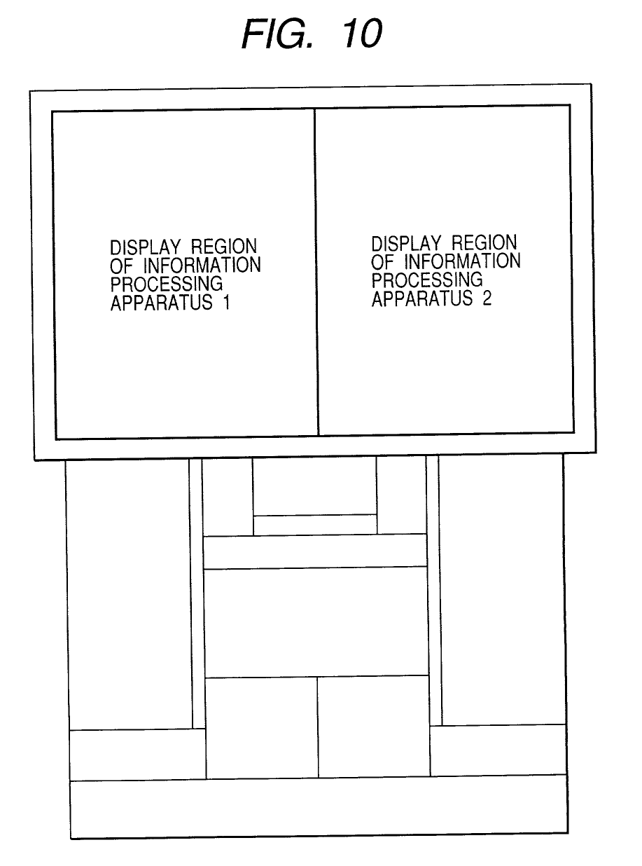

One example of the display form for the display apparatus 1 of Embodiment 5 will now be described, using FIG. 10.

FIG. 10 shows one example of the display form for the display apparatus of Embodiment 5.

In Embodiment 5, the situation is shown in which the screen of the display apparatus 1 is divided into two sections to project the respective images of the information processing apparatuses 1 and 2 side by side. The configuration in which the images of two information processing apparatuses are projected side by side is not particularly limited.

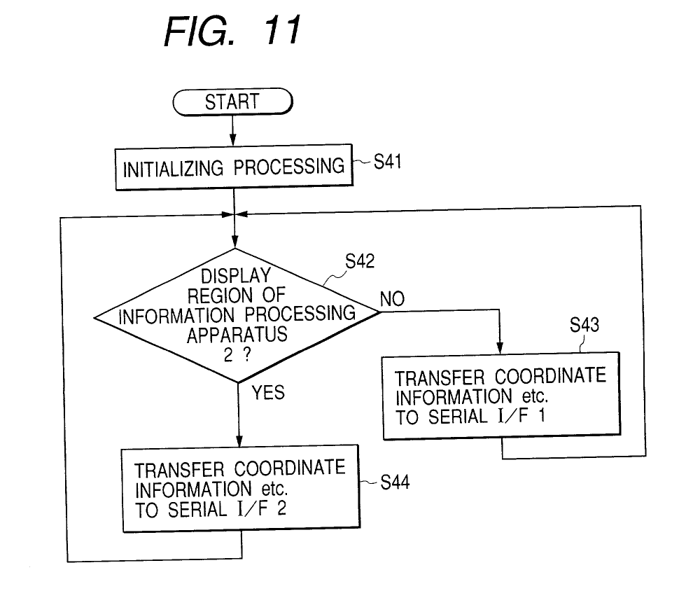

Processing performed in the display apparatus of Embodiment 5 will now be described, using FIG. 11.

FIG. 11 is a flowchart showing processing performed in the display apparatus of Embodiment 5.

Furthermore, in Embodiment 5, manipulation on the coordinate input device emulates an operation of a mouse, thereby sending the input signal constituted by coordinate information and button information to the information processing apparatus.

First, at step S41, initializing processing for the coordinate input device is performed. At step S42, whether or not the coordinate of the coordinate input device exists in the display region of the information processing apparatus 2 is determined. If the coordinate of the coordinate input device does not exist in the display region of the information processing apparatus 2 (if the result of the step S42 is NO), the process proceeds to step S43, where the input signal of coordinate information, etc. is sent to the serial interface 7 connected to the information processing apparatus 1, and the process returns to step S42. In this case, the coordinate is converted into an absolute coordinate of the display region of the information processing apparatus 1, and the absolute coordinate is sent to the information processing apparatus 1.

On the other hand, if the coordinate of the coordinate input device exists in the display region of the information processing apparatus 2 (if the result of the step S42 is YES), the process proceeds to step S44, where the input signal of coordinate information, etc. is sent to the serial interface 8 connected to the information processing apparatus 2, and the process returns to step S42. In this case, the coordinate is converted into an absolute coordinate of the display region of the information processing apparatus 2, the absolute coordinate is sent to the information processing apparatus 2.

As described above, according to Embodiment 5, based on a indicated coordinate by the coordinate input device, the information processing apparatus to which the input signal obtained from the indicated coordinate is outputted is selected, at the time of dividing the screen of the display apparatus 1 into two sections to display the respective display regions of the information processing apparatuses 1 and 2. Then, the input signal of coordinate information, etc. of the coordinate input device can be sent to this selected information processing apparatus. Thereby, a plurality of information processing apparatuses can be connected to one display apparatus 1 having a coordinate input device to use the coordinate input device as the coordinate input device of each information processing apparatus.

### Embodiment 6

In Embodiment 6, the case will be described where screens of three information processing apparatuses are projected onto the display apparatus 1.

Furthermore, since the configuration of the display apparatus 1 is same as that of Embodiment 1, the explanation thereof will not be presented.

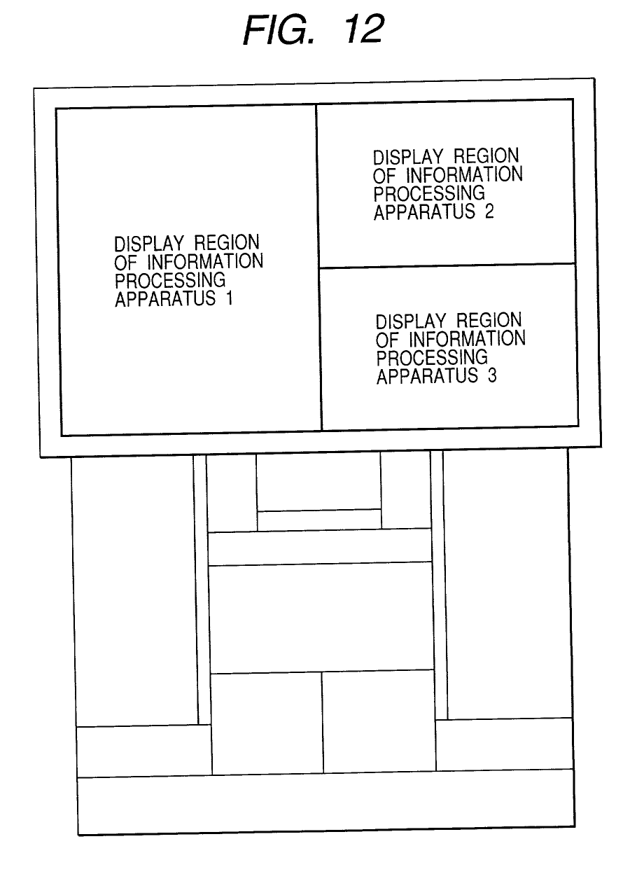

One example of the display form for the display apparatus 1 of Embodiment 6 will now be described, using FIG. 12.

FIG. 12 shows one example of the display form for the display apparatus of Embodiment 6.

In Embodiment 6, the situation is shown in which the screen of the display apparatus is divided into three sections to project the respective images of the information processing apparatuses 1 to 3 side by side. The configuration in which the images of three information processing apparatuses are projected side by side is not particularly limited.

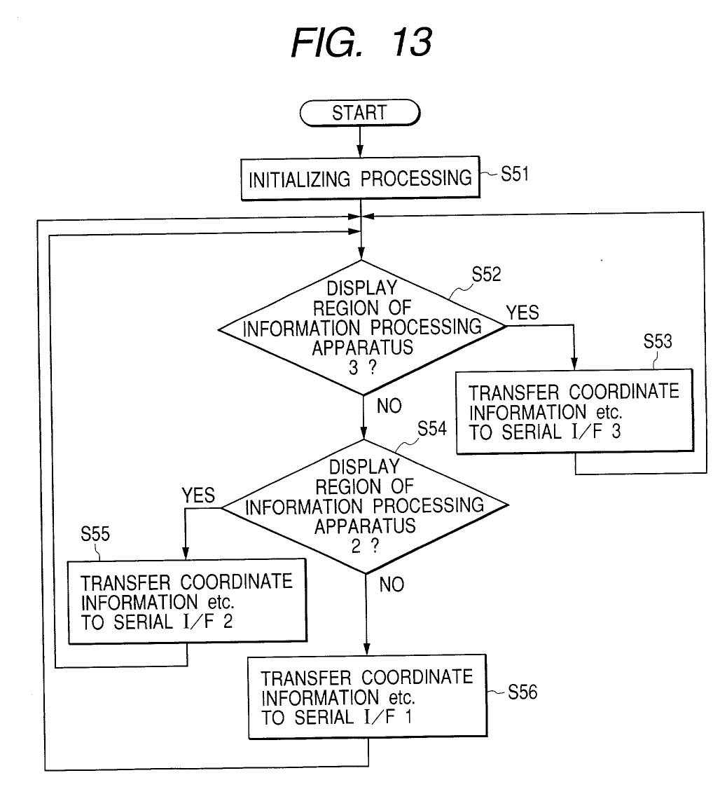

Processing performed in the display apparatus of Embodiment 6 will now be described, using FIG. 13.

FIG. 13 is a flowchart showing processing performed in the display apparatus of Embodiment 6.

Furthermore, in Embodiment 6, manipulation on the coordinate input device emulates an operation of a mouse, thereby sending the input signal constituted by coordinate information and button information to the information processing apparatus.

First, at step S51, initializing processing for the coordinate input device is performed. At step S52, whether or not the coordinate of the coordinate input device exists in the display region of the information processing apparatus 3 is determined. If the coordinate of the coordinate input device exists in the display region of the information processing apparatus 3 (if the result of the step S52 is YES), the process proceeds to step S53, where the input signal of coordinate information, etc. is sent to the serial interface 9 connected to the information processing apparatus 3, and the process returns to step S52. In this case, the coordinate is converted into an absolute coordinate of the display region of the information processing apparatus 3, and the absolute coordinate is sent to the information processing apparatus 3.

On the other hand, if the coordinate of the coordinate input device does not exist in the display region of the information processing apparatus 3 (if the result of step S52 is NO), the process proceeds to step S54, where whether or not the coordinate of the coordinate input devise exists in the information processing apparatus 2 is determined. If the coordinate of the coordinate input device exists in the display region of the information processing apparatus 2 (if the result of the step S54 is YES), the process proceeds to step S55, where the input signal of coordinate information, etc. is sent to the serial interface 8 connected to the information processing apparatus 2, and the process returns to step S52. In this case, the coordinate is converted into an absolute coordinate of the display region of the information processing apparatus 2, the absolute coordinate is sent to the information processing apparatus 2.

On the other hand, if the coordinate of the coordinate input device does not exist in the display region of the information processing apparatus 2 (if the result of step S54 is NO), the process proceeds to step S56, where the input signal of coordinate information, etc. is sent to the serial interface 7 connected to the information processing apparatus 1, and the process returns to step S52. In this case, the coordinate is converted into an absolute coordinate of the display region of the information processing apparatus 1, the absolute coordinate is sent to the information processing apparatus 1.

As described above, according to Embodiment 6, based on a indicated coordinate by the coordinate input device, the information processing apparatus to which the input signal obtained from the indicated coordinate is outputted is selected, at the time of dividing the screen of the display apparatus 1 into three sections to display the respective display regions of the information processing apparatuses 1 to 3. Then, the input signal of coordinate information, etc. of the coordinate input device can be sent to this selected information processing apparatus. Thereby, a plurality of information processing apparatuses can be connected to one display apparatus 1 having a coordinate input device to use the coordinate input device as the coordinate input device of each information processing apparatus.

Furthermore, for the present invention, cases have been described where two or three information processing apparatuses are connected to the display apparatus, but a configuration in which four or more information processing apparatuses are connected thereto may easily be achieved. In this case, the RGB signal interface and the serial interface for each information processing apparatus are provided as a matter of course.

Also, in the case where communication interfaces capable of performing high capacity data transfer such as optical fibers are used as communication circuits, it is possible to provide only one of the communication interfaces in the display apparatus, and connect a plurality of information processing apparatuses by the communication interface and hub or bus connection to send the input signal of coordinate information, etc. to a selected information processing apparatus by time-division or packet transmission or the like.

Also, in the case where image data communication interfaces capable of performing high capacity data transfer such as optical fibers are used as receiving circuits, it is possible to provide only one of the communication interfaces in the display apparatus, and connect a plurality of information processing apparatuses by the communication interface and hub or bus connection to input image data of the information processing apparatus by time-division or packet transmission or the like.

Also, for the present invention, a digitizer is used as a coordinate input device, but other coordinate input devices such as a pointer of remote control may be used. Also, the coordinate input device is connected to the information processing apparatus using the serial interface, but other communication interfaces may be used. Also, a liquid crystal panel is used as a display unit, but other display devices such as a CRT may be used.

Furthermore, the present invention may be applied to a system constituted by a plurality of apparatuses (for example, a host computer, interface apparatus, reader, printer, etc.), or may be applied to equipment constituted by one apparatus (for example, a copying machine, facsimile machine, etc.).

Also, needless to say, the object of the present invention may also be achieved by supplying a storage medium having recorded therein a program code of software for achieving the functions of the aforesaid embodiments to a system or apparatus and having the program code stored in the storage medium read and executed by the computer (or CPU and MPU) of the system or the apparatus.

In this case, the program code read from the storage medium itself achieves the functions of the aforesaid embodiments, and thus the storage medium having the program code recorded therein composes the present invention.

For storage media for supplying program codes, for example, a floppy disk, a hard disk, an optical disk, a magneto-optical disk, a CD-ROM, a CD-R/RW, a DVD-ROM/RAM, a magnetic tape, a nonvolatile memory card, a ROM and the like may be used.

Also, needless to say, not only the case where the functions of the aforesaid embodiments are achieved by executing the program code read by the computer, but also the case where the OS (operating system) or the like operating on the computer performs part or all of the actual processing based on the instructions of the program code, whereby the functions of the aforesaid embodiments are achieved is included.

Furthermore, needless to say, the case is also included where after the program code read from the storage medium is written in a feature expansion board inserted in the computer and a feature expansion unit connected to the computer, the CPU or the like provided in the feature expansion board and the feature expansion unit performs part or all of actual processing based on the instructions of the program code, whereby the functions of the aforesaid embodiments are achieved.

When the present invention is applied to the above described storage medium, the program code corresponding to the flowchart described previously is stored in the medium.

As described above, according to the present invention, a display apparatus capable of displaying images from a plurality of information processing apparatuses on one display apparatus and controlling the plurality of information processing apparatuses by one input device, and a method and a program for controlling the same can be provided.

What is claimed is:

1. A display apparatus displaying images from a plurality of information processing apparatuses, comprising:
image inputting means for inputting respective image signals from said plurality of information processing apparatuses;
display controlling means for constructing on a display screen display regions in which respective image signals from said plurality of information processing apparatuses are displayed;
inputting means for inputting a signal containing coordinate information;
determining means for determining an information processing apparatus to which the input signal is sent, based on the input signal inputted by said inputting means; and
communication means for sending said input signal to the information processing apparatus determined by said determining means.

2. The display apparatus according to claim 1, wherein said determining means determines an information processing apparatus to which the input signal is sent, based on the coordinate on said display screen indicated by said input signal.

3. The display apparatus according to claim 1, wherein said display controlling means displays on a first display region an image signal from a first information processing apparatus, and displays on a second display region at least one image signal from a second information processing apparatus in the first display region.

4. The display apparatus according to claim 1, wherein said display controlling means divides said display screen into screens, the number of which is equal to the number of said plurality of information processing apparatuses, to construct display regions in which respective image signals from the plurality of information processing apparatuses are displayed.

5. The display apparatus according to claim 1, wherein said determining means converts the coordinate information indicated by said input signal into absolute coordinate information of a display region corresponding to the information processing apparatus to which the input signal is sent.

6. A method for controlling a display apparatus displaying images from a plurality of information processing apparatuses, comprising:
an image inputting step of inputting respective image signals from said plurality of information processing apparatuses;
a display controlling step of constructing on a display screen display regions in which respective image signals from said plurality of information processing apparatuses are displayed;
an inputting step of inputting a signal containing coordinate information;
a determining step of determining an information processing apparatus to which the input signal is sent, based on the input signal inputted in said inputting step; and
a communicating step of sending said input signal to the information processing apparatus determined in said determining step.

7. The method according to claim 6, wherein in said determining step, an information processing apparatus to which the input signal is sent is determined, based on the coordinate on said display screen indicated by said input signal.

8. The method according to claim 6, wherein in said display controlling step, an image signal from a first information processing apparatus is displayed on a first display region, and at least one image signal from a second information processing apparatus is displayed on a second display region in the first display region.

9. The method according to claim 6, wherein in said display controlling step, said display screen is divided into screens, the number of which is equal to the number of said plurality of information processing apparatuses, to construct display regions in which respective image signals from the plurality of information processing apparatuses is displayed.

10. The method according to claim 6, wherein in said determining step, the coordinate information indicated by said input signal converted into absolute coordinate information of a display region corresponding to the information processing apparatus to which the input signal is sent.

11. A program for making a computer perform control of a display apparatus displaying images from a plurality of information processing apparatuses, comprising:
a program code of an image inputting step of inputting respective image signals from said plurality of information processing apparatuses;
a program code of a display controlling step of constructing on a display screen display regions in which respective image signals from said plurality of information processing apparatuses are displayed;
a program code of an inputting step of inputting a signal containing coordinate information;
a program code of a determining step of determining an information processing apparatus to which the input signal is sent, based on the input signal inputted in said inputting step; and
a program code of a communicating step of sending said input signal to the information processing apparatus determined in said determining step.

12. A display apparatus performing display based on a first image signal, which is an image signal from a first information processing apparatus that performs a predetermined information processing based on a coordinate signal representing a predetermined position on the screen displayed on the basis of a signal outputted by the apparatus, and a second image signal, which is an image signal from a second information processing apparatus that performs a predetermined information processing based on a coordinate signal representing a predetermined position on the screen displayed on the basis of a signal outputted by the apparatus, the display device comprising:
a receiving circuit receiving said first image signal and said second image signal;
a coordinate information receiving circuit receiving signals from a coordinate input device that transforms into a signal an indicated position on a display surface on which a screen based on said first image signal or a screen based on said second image signal or a screen based on both of said first image signal and said second image signal is displayed;
a determination circuit determining whether the input signal inputted from the coordinate information receiving circuit is outputted to said first information processing apparatus or to said second information processing apparatus; and
a communication circuit sending said input signal to the information processing apparatus determined by said determination circuit.

13. The display apparatus according to claim 12, said apparatus further comprising said coordinate input device.

14. The display apparatus according to claim 13, wherein said coordinate input device is provided in such a manner that the coordinate device is placed over said display surface.

15. The display apparatus according to claim 13, wherein said coordinate input device electrically or optically reads the indicated position on said display surface.

16. The display apparatus according to claim 14, wherein said coordinate input device electrically or optically reads the indicated position on said display surface.

17. The display apparatus according to claim 12, wherein said determination circuit determines an information processing apparatus to which said input signal is sent, according to information that is given externally.

18. The display apparatus according to claim 13, wherein said determination circuit determines an information processing apparatus to which said input signal is sent, according to information that is given externally.

19. The display apparatus according to claim 14, wherein said determination circuit determines an information processing apparatus to which said input signal is sent, according to information that is given externally.

20. The display apparatus according to claim 15, wherein said determination circuit determines an information processing apparatus to which said input signal is sent, according to information that is given externally.

21. The display apparatus according to claim 16, wherein said determination circuit determines an information processing apparatus to which said input signal is sent, according to information that is given externally.

22. The display apparatus according to claim 12, wherein said determination circuit determines an information processing apparatus to which said input signal is sent, based on said input signal.

23. The display apparatus according to claim 13, wherein said determination circuit determines an information processing apparatus to which said input signal is sent, based on said input signal.

24. The display apparatus according to claim 14, wherein said determination circuit determines an information processing apparatus to which said input signal is sent, based on said input signal.

25. The display apparatus according to claim 15, wherein said determination circuit determines an information processing apparatus to which said input signal is sent, based on said input signal.

26. The display apparatus according to claim 16, wherein said determination circuit determines an information processing apparatus to which said input signal is sent, based on said input signal.

27. The display apparatus according to claim 17, wherein said determination circuit determines an information processing apparatus to which said input signal is sent, based on said input signal.

28. The display apparatus according to claim 18, wherein said determination circuit determines an information processing apparatus to which said input signal is sent, based on said input signal.

29. The display apparatus according to claim 19, wherein said determination circuit determines an information processing apparatus to which said input signal is sent, based on said input signal.

30. The display apparatus according to claim 20, wherein said determination circuit determines an information processing apparatus to which said input signal is sent, based on said input signal.

31. The display apparatus according to claim 21, wherein said determination circuit determines an information processing apparatus to which said input signal is sent, based on said input signal.

32. The display apparatus according to any of claims 12 to 31, further comprising a conversion circuit to convert said input signal, so that the information processing apparatus to which said input signal is sent can use the signal sent from this display apparatus without using information indicating where the display region in which the image signal outputted by the information processing apparatus is positioned on said display surface.
